(19) United States
(12) Patent Application Publication
(10) Pub. No.: US 2025/0356578 A1
(43) Pub. Date: Nov. 20, 2025

(54) IMAGE PROCESSING METHOD AND APPARATUS, ELECTRONIC DEVICE, AND STORAGE MEDIUM

(71) Applicant: Lemon Inc., Grand Cayman (KY)

(72) Inventors: Yangyue Wan, Los Angeles, CA (US); Lin Li, Beijing (CN); Xiaohui Shen, Los Angeles, CA (US)

(21) Appl. No.: 18/873,161

(22) PCT Filed: Jun. 1, 2023
(86) PCT No.: PCT/SG2023/050395

§ 371 Date: Dec. 9, 2024

(30) Foreign Application Priority Data
Jun. 10, 2022 (CN) 202210658011.3

(51) Int. Cl. G06T 15/10; G06T 7/73; G06V 10/44; G06V 10/77; G06V 10/774; G06V 10/776; G06V 10/82; G06V 40/16

(52) U.S. Cl. CPC G06T 15/10; G06T 7/74; G06V 10/443; G06V 10/7715; G06V 10/7747; G06V 10/776; G06V 40/171; G06T 2207/20081; G06T 2207/20084; G06T 2207/30201; G06V 10/82

(57) ABSTRACT

The present disclosure provides an image processing method, an apparatus, an electronic device and a storage medium. The image processing method comprises: obtaining an original image of a target object to be processed, wherein the preset elements in the original image are displayed in a first display form; inputting the original image into a pre-trained element removal processing model to obtain a preset element removal image for the target object, and matching the preset element removal image with a template image corresponding to the preset element displayed in a second display form based on the preset attribute parameters of the target object; inputting the preset element removal image, the template image and the mask image of the preset element in the template image into a preset image element migration model to obtain a target image for the target object.

This application claims priority to the Chinese patent application filed with the China Patent Office on Jun. 10, 2022, with application No. 202210658011.3, the contents of which are incorporated herein by reference in its entirety.

### FIELD

The present disclosure relates to the field of image processing technology, for example, to image processing method, apparatus, electronic device and storage media.

### BACKGROUND

Hairstyle is an important part of personal image, and people have a wide demand for trying different hairstyles. Many users will experience their different hairstyles through applications with hairstyle transformation special effects.

Most methods of implementing hairstyle transformation are based on computer vision and graphics technology which attach pre-made two-dimensional (2D) hair materials to the head according to the facial posture in the face image. However, the hairstyle material and gloss in this hairstyle transformation method are quite different from real hair, and the effect of hairstyle migration is not realistic and natural enough. Especially when the original hairstyle image is a side face image, the application of new hairstyle materials will be limited, and the hairstyle migration effect needs to be improved.

### SUMMARY

The present disclosure provides a method, apparatus, electronic device and storage medium for image processing, so as to achieve a higher fit between the preset elements after the change of the display form and other elements in the original image when the element display form in the image is changed, in order to make effect of the image special effect processing more natural.

In a first aspect, the present disclosure provides a method for image processing, which includes:
obtaining an original image of a target object to be processed, wherein the preset element in the original image is displayed in a first display form;
inputting the original image into a pre-trained element removal processing model to obtain a preset element removal image of the target object, and matching the preset element removal image with a template image corresponding to the preset element displayed in a second display form based on the preset attribute parameters of the target object; and
inputting the preset element removal image, the template image and the mask image of the preset element in the template image into a preset image element migration model to obtain a target image for the target object, wherein the preset element in the target image is displayed in the second display form.

In the second aspect, the present disclosure further provides an apparatus for image processing, which includes:
an image obtaining module, configured to obtain an original image of a target object to be processed, wherein the preset element in the original image is displayed in a first display form;
a template matching module, configured to input the original image into a pre-trained element removal processing model to obtain a preset element removal image of the target object, and match the preset element removal image with a template image corresponding to the preset element displayed in a second display form based on preset attribute parameters of the target object; and
an image processing module, configured to input the preset element removal image, the template image, and the mask image of the preset element in the template image into a preset image element migration model to obtain a target image for the target object, wherein the preset element in the target image is displayed in the second display form.

In the third aspect, the present disclosure further provides an electronic device, which includes:
one or more processors;
a storage apparatus, configured to store one or more programs;
when the one or more programs are executed by the one or more processors, the one or more processors implement the above-mentioned image processing method.

In a fourth aspect, the present disclosure further provides a storage medium containing computer executable instructions, wherein the computer executable instructions are used to perform the above-mentioned image processing method when executed by a computer processor.

In a fifth aspect, the present disclosure further provides a computer program product, including a computer program carried on a non-transitory computer readable medium, wherein the computer program contains program code for performing the above-mentioned image processing method.

### BRIEF DESCRIPTION OF THE FIGURES

FIG. 1 is a flowchart of a method for image processing provided by an embodiment of the present disclosure;

FIG. 2 is a flowchart of another image processing method provided by an embodiment of the present disclosure;

FIG. 3 is a flowchart of another image processing method provided by an embodiment of the present disclosure;

FIG. 4 is a schematic diagram of a training process of a preset image element migration model provided by an embodiment of the present disclosure;

FIG. 5 is a schematic diagram of the structure of an apparatus for image processing provided by an embodiment of the present disclosure;

FIG. 6 is a schematic diagram of the structure of an electronic device provided by an embodiment of the present disclosure.

### DETAILED DESCRIPTION OF EMBODIMENTS

The embodiments of the present disclosure will be described in more detail below with reference to the accompanying drawings. Although some embodiments of the present disclosure are shown in the accompanying drawings, the present disclosure can be implemented in various forms, and these embodiments are provided for understanding the present disclosure. The drawings and embodiments of the present disclosure are for exemplary purposes only.

The multiple steps described in the method implementation of the present disclosure can be performed in different orders and/or in parallel. In addition, the method implementation may include additional steps and/or omit the steps shown. The scope of the present disclosure is not limited in this respect.

The term “include” and its variations used herein are open inclusions, i.e., “include”. The term “based on” means “based at least in part”. The term “one embodiment” means “at least one embodiment”; the term “another embodiment” means “at least one other embodiment”; the term “some embodiments” means “at least some embodiments”. The relevant definitions of other terms will be given in the following description.

The concepts of “first”, “second”, etc. mentioned in the present disclosure are only used to distinguish different devices, modules or units, and are not used to limit the order or interdependence of the functions performed by these apparatus, modules or units.

The modifications of “one” and “multiple” mentioned in the present disclosure are illustrative rather than restrictive. Those skilled in the art should understand that, unless otherwise specified in the context, they should be understood as “one or more”.

Before using the technical solution disclosed in the embodiment of the present disclosure, the type, scope of use, and usage scenarios of the personal information involved in the present disclosure should be informed to the user and the user's authorization should be obtained in an appropriate manner in accordance with relevant laws and regulations.

For example, in response to receiving an active request from the user, a prompt message is sent to the user to clearly prompt the user that the operation requested to be performed will require the obtaining and use of the user's personal information. Thus, the user can autonomously choose whether to provide personal information to software or hardware such as an electronic device, application, server or storage medium that performs the operation of the technical solution of the present disclosure according to the prompt message.

As an implementation method, in response to receiving an active request from the user, the method of sending the prompt message to the user can be, for example, a pop-up window, in which the prompt message can be presented in text. In addition, the pop-up window can also carry a selection control for the user to choose “agree” or “disagree” to provide personal information to the electronic device.

The above notification and user authorization process are only illustrative and do not limit the implementation of the present disclosure. Other methods that meet relevant laws and regulations can also be applied to the implementation of the present disclosure.

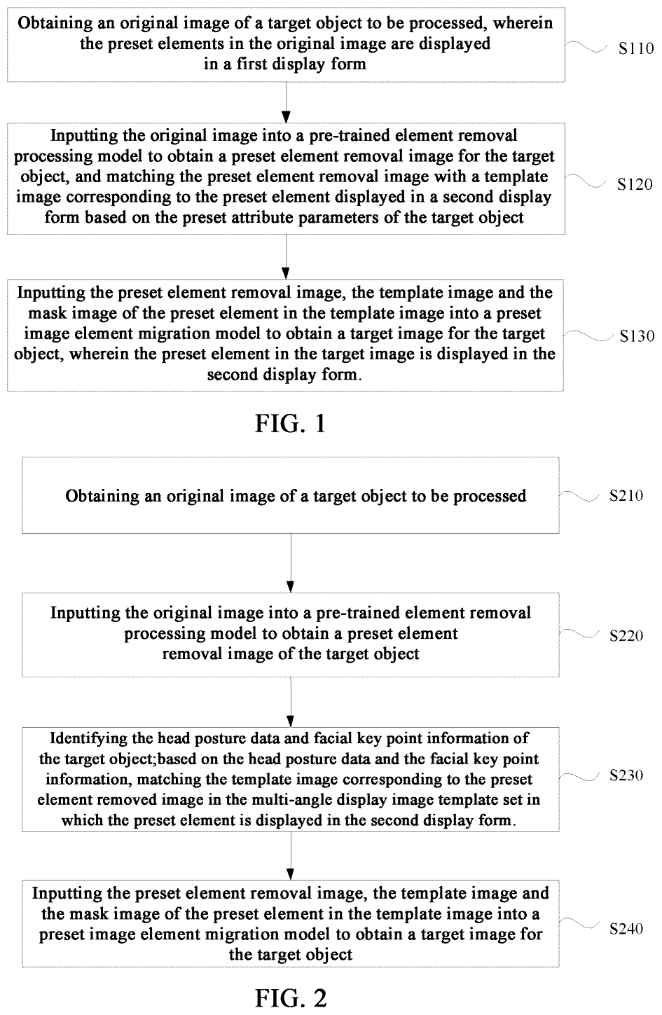

FIG. 1 is a flow chart of a method for image processing provided by an embodiment of the present disclosure. The embodiment of the present disclosure is applicable to the situation of changing the display form of elements in an image. The method can be executed by an apparatus for image processing, which may be implemented in the form of software and/or hardware, for example, by an electronic device, which can be a mobile terminal, a personal computer (PC) or a server.

As shown in FIG. 1, the image processing method includes:

S110, obtaining an original image of the target object to be processed, wherein the preset element in the original image is displayed in a first display form.

The original image may be an image that needs to be processed with image special effects, and can be an image obtained by downloading, shooting or uploading.

The target object is a foreground object or an object in an area of interest in the original image. The target object may be any of a human object, an animal object or a static object.

The preset element is a part of the target object. For example, if the target object is a person object, the preset element can be the facial features, hair, jewelry, clothing and other elements of the person object; or, if the target object is a toy house, the preset element can be any ornament element in the toy house.

The first display form of the preset element may be understood as the initial display form of the preset element in the original image. For example, the original hairstyle of the person object is shoulder-length hair; for another example, the table ornament in the toy house object is a round table.

When the user triggers the corresponding image special effect processing function in an application with a special effect processing function for changing the display form of the preset element in the image, the user will be prompted to take or upload a real-time image to obtain the original image containing the target object.

S120, inputting the original image into a pre-trained element removal processing model to obtain the preset element removal image of the target object, and match the preset element removal image with the corresponding template image of the preset element displayed in the second display form based on the preset attribute parameters of the target object.

The second display form of the preset element is the target display form of the preset element in the image special effect processing effect. For example, after the original image is processed by the image special effect, the original shoulder-length hair of the character object is processed into neat short hair. Alternatively, after the original image is processed by the image special effect, the round dining table in the toy house is processed into a small square table.

In the related technologies, in order to achieve the technical effect of the display form transformation of the preset element, the image of the preset element of the second display form is usually directly superimposed on the preset element position of the original image, which may cause the preset element of the second display form to not completely fit with other elements in the original image, or a defect of the light being not coordinated and unnatural.

In order to overcome the above defects, in this embodiment, during the image special effect processing, the preset element of the first display form in the original image will be removed first to avoid affecting the effect of the fusion of the preset element of the second display form with other elements in the original image. When removing the preset element of the first display form, a pre-trained element removal processing model may be used for processing. That is, the original image is input into the pre-trained element removal processing model to obtain the preset element removal image of the corresponding target object. Among them, the image processing effect of the element removal processing model is as if the preset element has never existed, and the corresponding original preset element part will be displayed as the background of the original image or the effect of other elements corresponding to the target object. Instead of directly smearing the preset element of the first display form in the original image, the corresponding part of the removed preset element is represented by uniform black or other color pixel information.

The preset attribute parameters include one or more of the attribute parameters such as the angle, light parameters and contour parameters of the target object in the original image. According to the preset attribute parameters, the template image of the preset element displayed in the second display form that is closer in angle, light parameters or contour parameters can be matched to the original image as the basis for feature fusion in the image special effects processing process.

S130, the preset element removal image, the template image and the mask image of the preset element in the template image are input into the preset image element migration model to obtain the target image for the target object, wherein the preset element in the target image is displayed in the second display form.

In this embodiment, the preset element removal image, the template image in which the preset element matched in step S120 is displayed in the second display form, and the mask image of the preset element in the template image are used together as the input of the preset image element migration model, so that the preset image element migration model simultaneously extracts and learns the features of the three input images, and finally obtains the target image which corresponds to the original image and in which the preset element of the target object is displayed in the second display form. Among them, the mask image of the preset element in the template image can indicate the pixel area range when the preset element is displayed in the second display form. Therefore, the preset element in the target image displayed in the second display form may be integrated more naturally with other elements of the original image except the preset element.

In the process of image processing of the three input images by the preset image element transfer model, first, the preset image encoder of the preset image element transfer model performs feature fusion on the preset element removal image, the template image and the mask image in a high-dimensional space to obtain the target feature code; then, the target feature code is decoded by the image decoder of the preset image element transfer model to obtain the target image, wherein the image decoder is a pre-trained image generator, which can generate an image with preset elements according to the input feature vector after training.

Correspondingly, the training process of the preset image element transfer model is to train the preset image encoder according to the preset model training sample, so that the preset image encoder can perform feature encoding on the input image and obtain a feature encoding vector that can be correctly decoded by the image generator into the target image. The sample image without preset elements of the preset object in the model training sample, the preset display form template sample image of the preset element matching the image without preset elements, and the mask sample image of the preset element in the template sample image can be used as the model training sample pair; the model training sample pair is input into the initial image encoder to obtain the initial image feature code; then, the initial feature code is input into the image decoder to obtain the initial decoded image, and the initial image encoder is iteratively updated according to the loss between the decoded image and the template sample image to obtain the preset image encoder.

The technical solution of the disclosed embodiment is that in an image special effects processing scenario where it is necessary to switch the display form of preset elements in an image, when the original image of the target object to be processed is obtained, the original image is first input into a pre-trained element removal processing model to obtain a preset element removed image of the target object, and based on the preset attribute parameters of the target object, a template image in which the corresponding preset elements are displayed in a second display form is matched to the preset element removed image; finally, the preset element removed image, the template image and the mask image of the preset elements in the template image are input into a preset image element migration model to obtain a target image for the target object, wherein the preset element in the original image is displayed in the first display form, and the preset elements in the target image are displayed in the second display form. The technical solution of the embodiment of the present disclosure first removes the preset elements of the first display form during the image special effects processing, then comprehensively learns the features in the preset element removal image, the template image and the mask image of the preset elements in the template image, and fuses the preset elements of the second display form with other elements in the original image, thereby obtaining a better element fusion effect, solving the problem that the image effect is unnatural and the patch feeling is obvious when the preset elements of the target display form are directly superimposed on the preset elements of the original display form to change the display form of the preset elements in the related art. It improves the fit between the preset elements after the transformed display form and other elements in the original image during image special effects processing of the element display form in the transformed image, so that the effect of the image special effects processing is more natural and the effect of the special effects processing is more stable.

FIG. 2 is a flow chart of another image processing method provided by the embodiment of the present disclosure. Based on the above-mentioned method for image processing, it describes the image special effects processing process of transforming the display form of the preset elements when the target object is a human object and the preset element is hair. The method may be executed by an apparatus for image processing, and the apparatus can be implemented in the form of software and/or hardware, for example, by an electronic device, which can be a mobile terminal, a PC or a server, etc.

As shown in FIG. 2, the image processing method includes:

S210, obtaining the original image of the target object to be processed.

The preset element in the original image is displayed in a first display form.

In this embodiment, the target object is a person object, the preset element is hair, and accordingly, the first display form of the preset element is the initial hairstyle of the target object.

When the user triggers the corresponding hairstyle migration function in an application that can experience hairstyle design or hairstyle transformation function, the image of the target object may be taken in real time as the original image, or it can be the original image uploaded by the user containing the target object.

S220, inputting the original image into a pre-trained element removal processing model to obtain a preset element removal image of the target object.

Removing the preset element means removing the hair of the target object in the original image, and obtaining a bald head image of the target object corresponding to the original image.

The element removal processing model is a neural network model obtained by training based on a preset element removal image sample pair, wherein the preset element removal image sample pair includes an original sample image of an object containing the preset element, and a sample image corresponding to the original sample image that does not contain the preset element.

In one implementation, the obtaining process of the sample image that does not contain the preset element includes:

First, identify the outline of the subject that displays the preset element in the original sample image. Since the target object is an image of a human object, and the preset element is hair, the subject that displays the preset element of hair includes the head of the human object. When identifying the subject outline area, the head of the target object in the original image can be identified.

Then, the pixel points of the preset element located in the subject outline area are processed into pixel points that are consistent with the pixel information of the pixel points of the non-preset element in the subject outline area, and the pixel points of the preset element located outside the subject outline area are processed into pixel points that are consistent with the pixel information of the pixel points of the non-preset element outside the subject outline area, so that the sample image that does not contain the preset element can be obtained. The effect of such processing is that the pixel points of the preset element outside the skull area correspond to the background part of the original image after removal. After removing the hair in the skull area, the corresponding pixel point position corresponds to the scalp part, which may achieve the effect of seamlessly removing the preset element without affecting the display of other elements other than the preset element of the target object.

S230, identifying the head posture data and facial key point information of the target object, and based on the head posture data and the facial key point information, matching a template image corresponding to the preset element removed image in a multi-angle display image template set in which the preset element is displayed in the second display form.

The multi-angle display image template set in which the preset elements are displayed in the second display form is pre-established. In the process of establishing the set, first, a pre-made three-dimensional head model in which the preset elements are displayed in the second display form is obtained; then, the surround shooting process is simulated, and the three-dimensional head model is photographed and rendered at multiple angles to obtain images in which the preset elements are displayed in the second display form at multiple angles, thereby obtaining a multi-angle display image template set in which the preset elements are displayed in the second display form.

When performing template matching, first, the head posture data and facial key point information of the target object are identified. Among them, the head posture data refers to the angle of the head, including data such as pitch angle, rotation angle, and deflection angle, and the corresponding angle information can be determined according to the three-dimensional world coordinate system. Facial key points refer to key points such as facial features, and any algorithm that can realize facial key point recognition may be used to obtain the corresponding key point information. Then, the preset element removal image and the template map in the template set are respectively detected for head posture and facial key points, and matched in 3D space according to the corresponding parameters to find the template map closest to the preset element removal image.

In one implementation, the facial shape in the matched template image may also be corrected based on the facial geometry of the target object, so that the template image and the preset element removal image fit more accurately, and therefore the preset elements in the second display form in the final target image can be more naturally integrated with the elements in the preset element removal image.

S240, inputting the preset element removal image, the template image, and the mask image of the preset element in the template image into the preset image element migration model to obtain the target image for the target object.

Inputting the preset element removal image, the template image, and the template image into the preset image element migration model can enable the preset image element migration model to extract and learn the features of the three input images at the same time, and finally obtain a target image which corresponds to the original image and in which the preset elements of the target object are displayed in the second display form. For example, a short hair style with bangs is migrated to a new hair style of the target object in the original image, replacing the shoulder-length hair of the target object in the original image.

The technical solution of the disclosed embodiment is that in an image special effects processing scenario where it is necessary to switch the display form of preset elements in an image, when an original image to undergo processing with a person object as a target object is obtained, the original image is first input into a pre-trained element removal processing model to obtain a preset element removed image of the target object, and based on the head posture and facial key point information of the target object, a template image in which the preset elements are displayed in a second display form is matched to the preset element removed image; finally, the preset element removed image, the template image and the mask image of the preset elements in the template image are input into a preset image element migration model to obtain a target image for the target object, wherein the preset element in the original image is displayed in a first display form, and the preset elements in the target image are displayed in a second display form. The technical solution of the embodiment of the present disclosure, during the image special effects processing, first removes the preset elements of the first display form, and then fuses the preset elements of the second display form with other elements in the original image, thereby obtaining a better element fusion effect, solving the problem that the image effect is unnatural and the patch feeling is obvious when the preset elements of the target display form are directly superimposed on the preset elements of the original display form to change the display form of the preset elements in the related art. It improves the fit between the preset elements after the transformed display form and other elements in the original image in the image special effects processing of the element display form in the transformed image, so that the effect of the image special effects processing is more natural and the effect of the special effects processing is more stable.

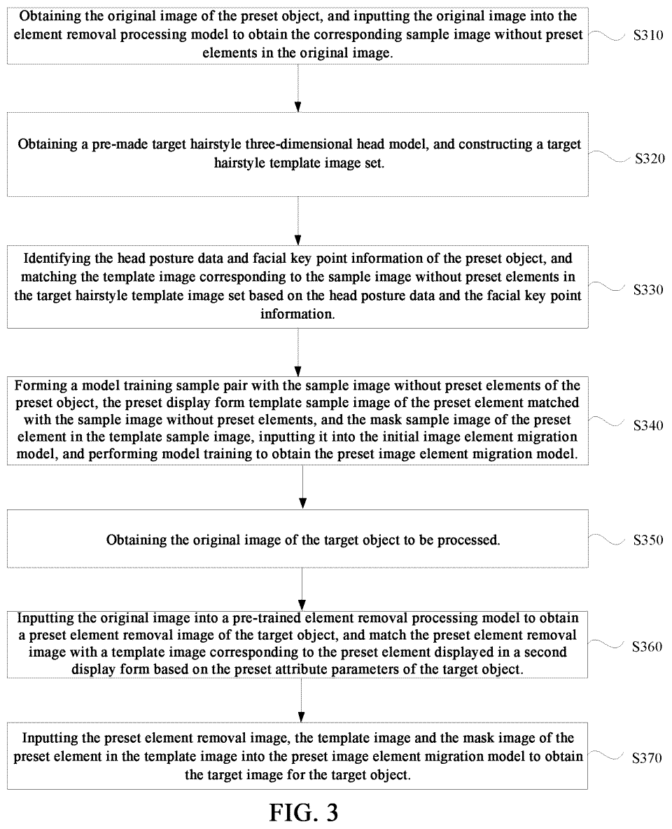

FIG. 3 is a flow chart of another image processing method provided by the embodiment of the present disclosure. In the process of implementing the flow of the method, the training process of the preset image element migration model when the target object is a human object and the preset element is hair, and the image special effects processing process of transforming the display form of the preset element based on the preset image element migration model are described. The method can be executed by an apparatus for image processing which can be implemented in the form of software and/or hardware, for example, by an electronic device which can be a mobile terminal, a PC or a server, etc.

S310, obtaining the original image of the preset object, and inputting the original image into the element removal processing model to obtain the corresponding sample image without preset elements in the original image.

The target object is a human object, the preset element is hair, and the initial hairstyle of the preset element of the preset object in the original image is recorded as the first display form. In different original images, the first display form of the preset element of the preset object can be different display forms.

The element removal processing model is a neural network model trained based on the preset element removal image sample pair, wherein the preset element removal image sample pair includes the original sample image of the object containing the preset element, and the sample image that corresponds to the original sample image and that does not contain the preset element.

S320, obtaining a pre-made target hairstyle three-dimensional head model, and constructing a target hairstyle template image set.

The target hairstyle is the target display form of the preset element of the preset object in the original image, that is, the second display form.

After obtaining the pre-made three-dimensional head model of the target hairstyle, the surround shooting process can be simulated, and the three-dimensional head model can be photographed and rendered at multiple angles to obtain images in which the preset elements are displayed in the second display form at multiple angles, thereby obtaining a multi-angle display image template set in which the preset elements are displayed in the second display form, that is, a target hairstyle template image set.

S330, identifying the head posture data and facial key point information of the preset object, and matching the template image corresponding to the sample image without preset elements in the target hairstyle template image set based on the head posture data and the facial key point information.

S340, forming a model training sample pair with the sample image without preset elements of the preset object, the preset display form template sample image of the preset element matched with the sample image without preset elements, and the mask sample image of the preset element in the template sample image, inputting it into the initial image element migration model, and performing model training to obtain the preset image element migration model.

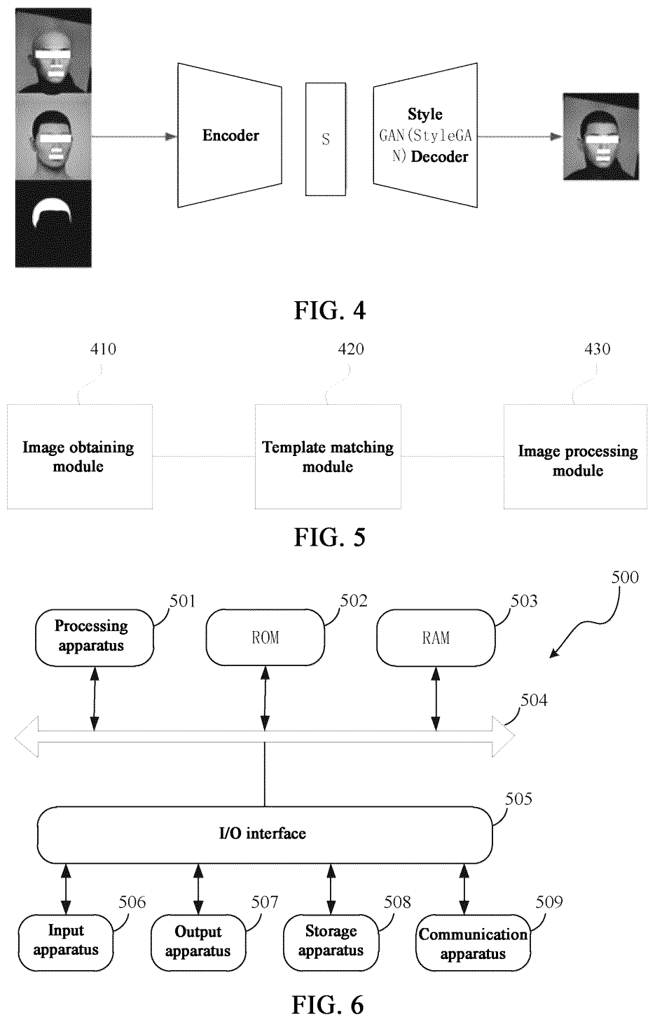

The model training process can refer to the training process shown in FIG. 4. In FIG. 4, the initial image element migration model includes an encoder module and a decoder module. The input of the encoder module is <a sample image without preset elements of a preset object, a template sample image matching the sample image without preset elements, and a mask sample image of a preset element in the template sample image>. The encoder module learns and extracts features from the input image to obtain an intermediate code S; then, the intermediate code S is input into the decoder module to obtain an element migration image output by the decoder module. The reference label image of the element migration image can be a pre-rendered image in which the preset elements corresponding to the original image of the preset object are displayed in a second display form. The initial image element migration model may be iteratively optimized according to the loss function value between the element migration image generated by the decoder and the reference label image, and finally the preset image element migration model is obtained.

During the model training process, the encoder module fuses image features in a high-dimensional space, and can map the fusion results to a face feature vector space that conforms to the natural distribution. Among them, since the decoder module is a pre-trained dedicated face Generator-Style Generative Adversarial Network (StyleGAN), during the image decoding process, it can be ensured that the generated result conforms to the characteristics of the real face, thereby achieving the purpose of improving the authenticity of the hairstyle migration. In one implementation, a discriminator can also be added to discriminate the consistency of the intermediate code S with the vector in the face feature vector set used to train StyleGAN, so as to help the model converge quickly.

S350, obtaining the original image of the target object to be processed.

The preset element of the target object in the original image is displayed in a first display form;

S360, inputting the original image into a pre-trained element removal processing model to obtain a preset element removal image of the target object, and match the preset element removal image with a template image corresponding to the preset element displayed in a second display form based on the preset attribute parameters of the target object.

S370, inputting the preset element removal image, the template image and the mask image of the preset element in the template image into the preset image element migration model to obtain the target image for the target object.

The preset elements of the target in the target image are displayed in the second display form.

The technical solution of the embodiment of the present disclosure obtains the corresponding sample image without preset elements by displaying the preset elements of the preset object in the first display form, then matches the template image in which the preset elements are displayed in the second display form for the sample image without preset elements, and forms a model training sample pair with the sample image without preset elements, the template sample image, and the mask sample image of the preset elements in the template sample image, and performs model training to obtain the preset image element migration model. In the scenario where element migration is required, when the original image of the target object to be processed is obtained, the original image is first input into the pre-trained element removal processing model to obtain the preset element removal image of the target object, and the preset element removal image is matched with the template image in which the corresponding preset elements are displayed in the second display form based on the preset attribute parameters of the target object; finally, the preset element removal image, the template image, and the mask image of the preset elements in the template image are input into the preset image element migration model to obtain the target image for the target object, wherein the preset element in the original image is displayed in the first display form, and the preset elements in the target image are displayed in the second display form. The technical solution of the embodiment of the present disclosure first removes the preset elements of the first display form during the image special effects processing, and then fuses the preset elements of the second display form with other elements in the original image, thereby obtaining a better element fusion effect, solving the problem that the image effect is unnatural and the patch feeling is obvious when the preset elements of the target display form are directly superimposed on the preset elements of the original display form to change the display form of the preset elements in the related art, and improves the fit between the preset elements after the changed display form and other elements in the original image when the image special effects processing of the element display form in the transformed image, so that the effect of the image special effects processing is more natural and the effect of the special effects processing is more stable.

FIG. 5 is a schematic diagram of the structure of an apparatus for image processing provided by the embodiment of the present disclosure, which is suitable for changing the display form of elements in the image, and can be implemented in the form of software and/or hardware. For example, the apparatus for image processing can be configured in an electronic device which can be a mobile terminal, a PC or a server.

As shown in FIG. 5, the apparatus for image processing includes: an image obtaining module 410, a template matching module 420 and an image processing module 430.

The image obtaining module 410 is configured to obtain an original image of a target object to be processed, wherein the preset element in the original image is displayed in a first display form; the template matching module 420 is configured to input the original image into a pre-trained element removal processing model to obtain a preset element removed image of the target object, and match the preset element removed image with a template image corresponding to the preset element displayed in a second display form based on preset attribute parameters of the target object; the image processing module 430 is configured to input the preset element removed image, the template image, and the mask image of the preset element in the template image into a preset image element migration model to obtain a target image for the target object, wherein the preset element in the target image is displayed in the second display form.

The technical solution provided by the embodiment of the present disclosure is that in an image special effects processing scenario where it is necessary to switch the display form of preset elements in an image, when the original image of the target object to be processed is obtained, the original image is first input into a pre-trained element removal processing model to obtain a preset element removed image of the target object, and based on the preset attribute parameters of the target object, a template image in which the corresponding preset elements are displayed in a second display form is matched to the preset element removed image; finally, the preset element removed image, the template image and the mask image of the preset elements in the template image are input into a preset image element migration model to obtain a target image for the target object, wherein the preset element in the original image is displayed in a first display form, and the preset elements in the target image are displayed in a second display form. The technical solution of the disclosed embodiment, during the image special effects processing, first removes the preset elements of the first display form, and then fuses the preset elements of the second display form with other elements in the original image, thereby obtaining a better element fusion effect, solving the problem that the image effect is unnatural and the patch feeling is obvious when the preset elements of the target display form are directly superimposed on the preset elements of the original display form to change the display form of the preset elements in the related art, and improves the fit between the preset elements after the transformed display form and other elements in the original image when the image special effects processing of the element display form in the transformed image is carried out, so that the effect of the image special effects processing is more natural and the effect of the special effects processing is more stable.

In one implementation, the image processing module 430 is configured to:
the preset image encoder of the preset image element migration model fuses the preset element removal image, the template image and the mask image to obtain the target feature code; the image decoder of the preset image element migration model decodes the target feature code to obtain the target image, wherein the image decoder is a pre-trained image generator.

In one implementation, the apparatus for image processing further includes a model training module, which is configured to train the preset image encoder, and the training process includes:
combining a sample image without preset elements of a preset object, a preset display form template sample image of the preset element matching the image without preset elements, and a mask sample image of the preset element in the template sample image, to form a model training sample pair; inputting the model training sample pair into an initial image encoder to obtain an initial image feature code; inputting the initial feature code into the image decoder to obtain an initial decoded image, and iteratively updating the initial image encoder according to the loss between the initial decoded image and the template sample image to obtain the preset image encoder.

In one implementation, the template matching module 420 is configured to:
identify the head posture data and facial key point information of the target object; based on the head posture data and the facial key point information, match the template image corresponding to the preset element removed image in the multi-angle display image template set in which the preset element is displayed in the second display form.

In one implementation, the apparatus for image processing further includes a template adjustment module, configured to:
based on the facial geometry of the target object, perform image correction on the facial shape in the template image.

In one implementation, the apparatus for image processing further includes a template set generation module, configured to:
obtain a pre-made three-dimensional head model in which the preset element is displayed in the second display form; simulate a surround shooting process, photograph and render the three-dimensional head model at multiple angles, obtain images of the preset element displayed in the second display form at multiple angles, and establish a multi-angle display image template set in which the preset element is displayed in the second display form.

In one implementation, the element removal processing model is a neural network model obtained by training based on a preset element removal image sample pair, wherein the preset element removal image sample pair includes an original sample image of an object containing the preset element, and a sample image which corresponds to the original sample image and does not contain the preset element.

In one implementation, the apparatus for image processing further includes an element removal processing model training module configured to:
identify the main body contour showing the preset element in the original sample image; process the pixel points of the preset element located in the main body contour area into pixel points consistent with the pixel information of the pixel points of the non-preset element in the main body contour area, and process the pixel points of the preset element located outside the main body contour area into pixel points consistent with the pixel information of the pixel points of the non-preset element outside the main body contour area, so as to obtain the sample image not containing the preset element;
perform model training based on the sample image not containing the preset element to obtain the element removal processing model.

The apparatus for image processing provided in the embodiment of the present disclosure can execute the image processing method provided in any embodiment of the present disclosure, and has the corresponding functional modules and effects of the execution method.

The multiple units and modules included in the above-mentioned apparatus are only divided according to functional logic, but are not limited to the above-mentioned division, as long as the corresponding functions can be realized; in addition, the names of the multiple functional units are only for the convenience of mutual distinction, and are not used to limit the protection scope of the embodiment of the present disclosure.

FIG. 6 is a structural schematic diagram of an electronic device provided in an embodiment of the present disclosure. Referring to FIG. 6 below, a schematic diagram of the structure of an electronic device (e.g., a terminal device or server in FIG. 6) 500 suitable for implementing the embodiment of the present disclosure is shown. The terminal device in the embodiment of the present disclosure may include mobile terminals such as mobile phones, laptop computers, digital broadcast receivers, personal digital assistants (PDAs), tablet computers (Portable Android Devices, PADs), portable multimedia players (Portable Media Players, PMPs), vehicle terminals (e.g., vehicle navigation terminals), etc., and fixed terminals such as digital televisions (TVs), desktop computers, etc. The electronic device 500 shown in FIG. 6 is only an example and should not impose any restrictions on the functions and scope of use of the embodiment of the present disclosure.

As shown in FIG. 6, the electronic device 500 may include a processing apparatus (e.g., a central processing unit, a graphics processor, etc.) 501, which may perform a variety of appropriate actions and processes according to a program stored in a read-only memory (ROM) 502 or a program loaded from a storage device 508 to a random access memory (RAM) 503. In RAM 503, a variety of programs and data required for the operation of the electronic device 500 are also stored. The processing apparatus 501, the ROM 502, and the RAM 503 are connected to each other via a bus 504. The input/output (I/O) interface 505 is also connected to the bus 504.

Typically, the following apparatus can be connected to the I/O interface 505: an input apparatus 506 including, for example, a touch screen, a touchpad, a keyboard, a mouse, a camera, a microphone, an accelerometer, a gyroscope, etc.; an output apparatus 507 including, for example, a liquid crystal display (LCD), a speaker, a vibrator, etc.; a storage apparatus 508 including, for example, a tape, a hard disk, etc.; and a communication apparatus 509. The communication apparatus 509 can allow the electronic device 500 to communicate with other devices wirelessly or wired to exchange data. Although FIG. 6 shows an electronic device 500 having a variety of apparatus, it is not required to implement or have all the apparatus shown. More or fewer apparatus may be implemented or have alternatively.

According to an embodiment of the present disclosure, the process described above with reference to the flowchart may be implemented as a computer software program. For example, an embodiment of the present disclosure includes a computer program product, which includes a computer program carried on a non-transitory computer-readable medium, and the computer program includes a program code for executing the method shown in the flowchart. In such an embodiment, the computer program can be downloaded and installed from a network through a communication apparatus 509, or installed from a storage device 508, or installed from a ROM 502. When the computer program is executed by the processing apparatus 501, the above functions defined in the method of the embodiment of the present disclosure are executed.

The names of the messages or information exchanged between multiple apparatus in the embodiment of the present disclosure are only for illustrative purposes, and are not used to limit the scope of these messages or information.

The electronic device provided in the embodiment of the present disclosure belongs to the same concept as the image processing method provided in the above embodiment. The technical details not described in detail in this embodiment can be referred to the above embodiment, and this embodiment has the same effect as the above embodiment.

The embodiment of the present disclosure provides a computer storage medium, on which a computer program is stored, and when the program is executed by a processor, the image processing method provided in the above embodiment is implemented.

The above-mentioned computer-readable medium of the present disclosure may be a computer-readable signal medium or a computer-readable storage medium or any combination of the above two. Computer readable storage media may be, for example, an electrical, magnetic, optical, electromagnetic, infrared, or semiconductor system, apparatus or device, or any combination thereof. Examples of computer readable storage media may include: an electrical connection with one or more wires, a portable computer disk, a hard disk, RAM, ROM, an erasable programmable read-only memory (EPROM or flash memory), an optical fiber, a portable compact disk read-only memory (CD-ROM), an optical storage device, a magnetic storage device, or any suitable combination thereof. In the present disclosure, a computer readable storage medium may be any tangible medium containing or storing a program that may be used by or in conjunction with an instruction execution system, apparatus or device. In the present disclosure, a computer readable signal medium may include a data signal propagated in a baseband or as part of a carrier wave, which carries a computer readable program code. Such propagated data signals may take a variety of forms, including electromagnetic signals, optical signals, or any suitable combination thereof. The computer-readable signal medium may also be any computer-readable medium other than a computer-readable storage medium, which may send, propagate or transmit a program for use by or in conjunction with an instruction execution system, apparatus or device. The program code contained on the computer-readable medium may be transmitted using any appropriate medium, including: wires, optical cables, radio frequencies (RF), etc., or any suitable combination of the above.

In some implementations, the client and the server may communicate using any currently known or future developed network protocol such as the HyperText Transfer Protocol (HTTP), and may be interconnected with any form or medium of digital data communication (e.g., a communication network). Examples of communication networks include local area networks (LANs), wide area networks (WANs), internets (e.g., the Internet), and peer-to-peer networks (e.g., ad hoc peer-to-peer networks), as well as any currently known or future developed networks.

The above-mentioned computer-readable medium may be contained in the above-mentioned electronic device; or it may exist alone without being assembled into the electronic device.

The computer-readable medium carries one or more programs, which when executed by the electronic device, cause the electronic device to:
obtain an original image of a target object to be processed, wherein the preset element in the original image is displayed in a first display form; input the original image to a pre-trained element removal processing model to obtain a preset element removed image of the target object, and match the preset element removed image with a template image corresponding to the preset element displayed in a second display form based on preset attribute parameters of the target object; input the preset element removed image, the template image, and the mask image of the preset element in the template image into a preset image element migration model to obtain a target image for the target object, wherein the preset element in the target image is displayed in the second display form.

The computer program code for performing the operations of the present disclosure can be written in one or more programming languages or a combination thereof, and the programming languages include object-oriented programming languages such as Java, Smalltalk, C++, and conventional procedural programming languages such as “C” language or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer via any type of network, including a LAN or WAN, or may be connected to an external computer (e.g., via the Internet using an Internet service provider).

The flowcharts and block diagrams in the accompanying drawings illustrate the possible architecture, functions, and operations of the systems, methods, and computer program products according to various embodiments of the present disclosure. In this regard, each box in the flowchart or block diagram may represent a module, a program segment, or a portion of a code, which contains one or more executable instructions for implementing a specified logical function. It should also be noted that in some alternative implementations, the functions marked in the box may also occur in an order different from that marked in the accompanying drawings. For example, two boxes represented in succession may actually be executed substantially in parallel, and they may sometimes be executed in reverse order, depending on the functions involved. It should also be noted that each box in the block diagram and/or flowchart, and the combination of boxes in the block diagram and/or flowchart, can be implemented by a dedicated hardware-based system that performs the specified function or operation, or can be implemented by a combination of dedicated hardware and computer instructions.

The units involved in the embodiments described in the present disclosure can be implemented by software or by hardware. Among them, the name of the unit does not constitute a limitation on the unit itself in some cases. For example, the first obtaining unit can also be described as “a unit for obtaining at least two Internet Protocol addresses”.

The functions described above in this article can be performed at least in part by one or more hardware logic components. For example, without limitation, exemplary types of hardware logic components that can be used include: Field Programmable Gate Array (FPGA), Application Specific Integrated Circuit (ASIC), Application Specific Standard Parts (ASSP), System on Chip (SOC), Complex Programming Logic Device (CPLD), etc.

In the context of this disclosure, a machine-readable medium may be a tangible medium that may contain or store a program for use by or in conjunction with an instruction execution system, apparatus, or device. A machine-readable medium may be a machine-readable signal medium or a machine-readable storage medium. A machine-readable medium may include an electronic, magnetic, optical, electromagnetic, infrared, or semiconductor system, apparatus, or device, or any suitable combination of the foregoing. Examples of machine-readable storage media would include an electrical connection based on one or more wires, a portable computer disk, a hard disk, RAM, ROM, EPROM or flash memory, optical fiber, CD-ROM, an optical storage device, a magnetic storage device, or any suitable combination of the foregoing.

According to one or more embodiments of the present disclosure, [Example 1] provides a method for image processing, which includes:
obtaining an original image of a target object to be processed, wherein a preset element in the original image is displayed in a first display form;
inputting the original image into a pre-trained element removal processing model to obtain a preset element removed image of the target object, and matching the preset element removed image with a template image corresponding to the preset element displayed in a second display form based on preset attribute parameters of the target object;
inputting the preset element removed image, the template image, and the mask image of the preset element in the template image into a preset image element migration model to obtain a target image for the target object, wherein the preset element in the target image is displayed in the second display form.

According to one or more embodiments of the present disclosure, [Example 2] provides a method for image processing, further comprising:

In some implementations, the process of the preset image element migration model performing image processing on the input image comprises:
performing feature fusion of the preset element removed image, the template image and the mask image by the preset image encoder of the preset image element migration model to obtain the target feature encoding;
decoding the target feature encoding through the image decoder of the preset image element migration model to obtain the target image, wherein the image decoder is a pre-trained image generator.

According to one or more embodiments of the present disclosure, [Example 3] provides a method for image processing, including:
in some implementations, the training process of the preset image encoder includes:
combining a sample image without preset elements of a preset object, a preset display form template sample image of the preset element matching the image without preset elements, and a mask sample image of the preset element in the template sample image to form a model training sample pair;
inputting the model training sample pair into an initial image encoder to obtain an initial image feature code;
inputting the initial feature code into the image decoder to obtain an initial decoded image, and iteratively updating the initial image encoder according to the loss between the initial decoded image and the template sample image to obtain the preset image encoder.

According to one or more embodiments of the present disclosure, [Example 4] provides a method for image processing, further comprising:
in some implementations, matching the preset element removed image with a template image corresponding to the preset element displayed in a second display form based on preset attribute parameters of the target object, including:
identifying the head posture data and facial key point information of the target object;
based on the head posture data and the facial key point information, in the multi-angle display image template set in which the preset element is displayed in the second display form, matching the template image corresponding to the preset element removal image.

According to one or more embodiments of the present disclosure, [Example 5] provides a method for image processing, further comprising:

In some implementations, after matching the preset element removal image with the template image corresponding to the preset element being displayed in the second display form, the method further comprises:
based on the facial geometry of the target object, performing an image correction on the facial shape in the template image.

According to one or more embodiments of the present disclosure, [Example 6] provides a method for image processing, further comprising:
in some implementations, the process of establishing a multi-angle display image template set in which the preset element is displayed in the second display form includes:
obtaining a pre-made three-dimensional head model in which the preset element is displayed in the second display form;
simulating a surround shooting process, photographing and rendering the three-dimensional head model at multiple angles, obtaining images of the preset element displayed in the second display form at multiple angles, so as to establish a multi-angle display image template set in which the preset element is displayed in the second display form.

According to one or more embodiments of the present disclosure, [Example 7] provides a method for image processing, further comprising:
in some implementations, the element removal processing model is a neural network model obtained by training based on a preset element removal image sample pair, wherein the preset element removal image sample pair includes an original sample image of an object containing the preset element, and a sample image corresponding to the original sample image that does not contain the preset element.

According to one or more embodiments of the present disclosure, [Example 8] provides a method for image processing, further comprising:
in some implementations, the process of obtaining the sample image that does not contain the preset element includes:
identifying the main outline of the preset element in the original sample image;
processing the pixel points of the preset element located in the main outline area into pixel points consistent with the pixel information of the pixel points of the non-preset element in the main outline area, and processing the pixel points of the preset element located outside the main outline area into pixel points consistent with the pixel information of the pixel points of the non-preset element outside the main outline area, to obtain the sample image that does not contain the preset element.

According to one or more embodiments of the present disclosure, [Example 9] provides an apparatus for image processing, including:
an image obtaining module, configured to obtain an original image of a target object to be processed, wherein the preset element in the original image is displayed in a first display form;
a template matching module, configured to input the original image into a pre-trained element removal processing model to obtain a preset element removal image of the target object, and match the preset element removal image with a template image corresponding to the preset element displayed in a second display form based on preset attribute parameters of the target object;
an image processing module, configured to input the preset element removal image, the template image, and the mask image of the preset element in the template image into a preset image element migration model to obtain a target image for the target object, wherein the preset element in the target image is displayed in the second display form.

According to one or more embodiments of the present disclosure, [Example 10] provides an apparatus for image processing, further comprising:
in one implementation, the image processing module is configured to:
perform feature fusion of the preset element removal image, the template image and the mask image by the preset image encoder of the preset image element migration model to obtain a target feature code;
decode the target feature code by the image decoder of the preset image element migration model to obtain the target image, wherein the image decoder is a pre-trained image generator.

According to one or more embodiments of the present disclosure, [Example 11] provides an apparatus for image processing, further comprising:
in one implementation, the apparatus for image processing further comprises a model training module, configured to train the preset image encoder, and the training process comprises:
combining a sample image without preset elements of a preset object, a template sample image of a preset element in a preset display form that matches the image without preset elements, and a mask sample image of the preset element in the template sample image to form a model training sample pair;
inputting the model training sample pair into an initial image encoder to obtain an initial image feature code;
inputting the initial feature code into the image decoder to obtain an initial decoded image, and iteratively updating the initial image encoder according to the loss between the initial decoded image and the template sample image to obtain the preset image encoder.

According to one or more embodiments of the present disclosure, [Example 12] provides an apparatus for image processing, further comprising:
in one implementation, the template matching module is configured to:
identify the head posture data and facial key point information of the target object;
based on the head posture data and the facial key point information, in a multi-angle display image template set in which the preset element is displayed in the second display form, match the template image corresponding to the preset element removed image.

According to one or more embodiments of the present disclosure, [Example 13] provides an apparatus for image processing, further including:
in one implementation, the apparatus for image processing further includes a template adjustment module configured to:
based on the facial geometry of the target object, perform image correction on the facial shape in the template image.

According to one or more embodiments of the present disclosure, [Example 14] provides an apparatus for image processing, further including:
in one implementation, the apparatus for image processing further includes a template set generation module configured to:
obtain a pre-made three-dimensional head model in which the preset element is displayed in the second display form;
simulate the surround shooting process, photograph and render the three-dimensional head model at multiple angles, obtain images in which the preset element is displayed in the second display form at multiple angles, so as to establish a multi-angle display image template set in which the preset element is displayed in the second display form.

According to one or more embodiments of the present disclosure, [Example 15] provides an apparatus for image processing, further including:
in one implementation, the element removal processing model is a neural network model obtained by training based on a preset element removal image sample pair, wherein the preset element removal image sample pair includes an original sample image of an object containing the preset element, and a sample image corresponding to the original sample image that does not contain the preset element.

According to one or more embodiments of the present disclosure, [Example 16] provides an apparatus for image processing, further comprising:
in one implementation, the apparatus for image processing further comprises an element removal processing model training module, configured to:
identify the main body contour showing the preset element in the original sample image;
process the pixel points of the preset element located in the main body contour area as pixel points consistent with the pixel information of the pixel points of the non-preset element in the main body contour area, and process the pixel points of the preset element located outside the main body contour area as pixel points consistent with the pixel information of the pixel points of the non-preset element outside the main body contour area, so as to obtain the sample image not containing the preset element;
perform model training based on the sample image not containing the preset element to obtain the element removal processing model.

In addition, although multiple operations are depicted in a specific order, this should not be understood as requiring these operations to be performed in the specific order shown or in a sequential order. In certain environments, multitasking and parallel processing may be advantageous. Similarly, although multiple implementation details are included in the above discussion, these should not be interpreted as limiting the scope of the present disclosure. Some features described in the context of separate embodiments can also be implemented in combination in a single embodiment. Conversely, various features that are described in the context of a single embodiment can also be implemented in multiple embodiments separately or in any suitable sub combinations.

1. A method for image processing, comprising:
obtaining an original image of a target object to be processed, wherein a preset element in the original image is displayed in a first display form;
inputting the original image into a pre-trained element removal processing model to obtain a preset element removal image for the target object, and matching the preset element removal image with a template image corresponding to the preset element displayed in a second display form based on preset attribute parameters of the target object; and
inputting the preset element removal image, the template image and a mask image of the preset element in the template image into a preset image element migration model to obtain a target image for the target object, wherein the preset element in the target image is displayed in the second display form.

2. The method of claim 1, wherein the process of the preset image element migration model performing the image processing on the input image comprises:
performing feature fusion on the preset element removed image, the template image, and the mask image by a preset image encoder of the preset image element migration model to obtain a target feature code; and
decoding the target feature code by an image decoder of the preset image element migration model to obtain the target image, wherein the image decoder is a pre-trained image generator.

3. The method of claim 2, wherein a training process of the preset image encoder comprises:
combining a sample image without the preset element of a preset object, a preset display form template sample image of the preset element matching the image without the preset element, and a mask sample image of the preset element in the template sample image, to form a model training sample pair;
inputting the model training sample pair into the initial image encoder to obtain an initial image feature code; and
inputting the initial feature code into the image decoder to obtain an initial decoded image, and iteratively updating the initial image encoder according to a loss between the initial decoded image and the template sample image to obtain the preset image encoder.

4. The method of claim 1, wherein matching the preset element removal image with the template image corresponding to the preset element displayed in the second display form based on the preset attribute parameters of the target object comprises:
identifying head posture data and facial key point information of the target object; and
based on the head posture data and the facial key point information, matching the template image corresponding to the preset element removed image in the multi-angle display image template set in which the preset element is displayed in the second display form.

5. The method of claim 1, wherein after matching the preset element removal image with the template image corresponding to the preset element displayed in the second display form, the method further comprises:
based on a facial geometry of the target object, performing image correction on a facial shape in the template image.

6. The method of claim 4, wherein the process of establishing the multi-angle display image template set in which the preset element is displayed in the second display form comprises:
obtaining a pre-made three-dimensional head model of the preset element displayed in the second display form; and
simulating a surround shooting process, photographing and rendering the three-dimensional head model at multiple angles, and obtaining images of the preset element displayed in the second display form at multiple angles to establish a multi-angle display image template set of the preset element displayed in the second display form.

7. The method of claim 1, wherein the element removal processing model is a neural network model obtained by training based on the preset element removal image sample pair, wherein the preset element removal image sample pair includes an original sample image of an object containing the preset element, and a sample image corresponding to the original sample image that does not contain the preset element.

8. The method of claim 7, wherein the process of obtaining the sample image that does not contain the preset element comprises:
identifying a main outline of the preset element in the original sample image; and
processing pixel points of the preset element located in the main outline area as pixel points consistent with pixel information of the pixel points of the non-preset element in the main outline area, and processing the pixel points of the preset element located outside the main outline area as pixel points consistent with the pixel information of the pixel points of the non-preset element outside the main outline area to obtain the sample image that does not contain the preset element.

9. (canceled)

10. An electronic device, comprising:
at least one processor;
a storage apparatus, configured to store at least one program;
when the at least one program is executed by the at least one processor, causing the at least one processor to;
obtain an original image of a target object to be processed, wherein a preset element in the original image is displayed in a first display form;
input the original image into a pre-trained element removal processing model to obtain a preset element removal image for the target object, and matching the preset element removal image with a template image corresponding to the preset element displayed in a second display form based on preset attribute parameters of the target object; and
input the preset element removal image, the template image and a mask image of the preset element in the template image into a preset image element migration model to obtain a target image for the target object, wherein the preset element in the target image is displayed in the second display form.

11. A non-transitory computer-readable storage medium, storing a computer program thereon, wherein the program, when executed by the processor, causing the processor to:
obtain an original image of a target object to be processed, wherein a preset element in the original image is displayed in a first display form;
input the original image into a pre-trained element removal processing model to obtain a preset element removal image for the target object, and matching the preset element removal image with a template image corresponding to the preset element displayed in a second display form based on preset attribute parameters of the target object; and
input the preset element removal image, the template image and a mask image of the preset element in the template image into a preset image element migration model to obtain a target image for the target object, wherein the preset element in the target image is displayed in the second display form.

12. (canceled)

13. The electronic device of claim 10, wherein the preset image element migration model of the electronic device is caused to perform the image processing on the input image by:
performing feature fusion on the preset element removed image, the template image, and the mask image by a preset image encoder of the preset image element migration model to obtain a target feature code; and
decoding the target feature code by an image decoder of the preset image element migration model to obtain the target image, wherein the image decoder is a pre-trained image generator.

14. The electronic device of claim 13, wherein the electronic device is caused to train the preset image encoder by:
combining a sample image without the preset element of a preset object, a preset display form template sample image of the preset element matching the image without the preset element, and a mask sample image of the preset element in the template sample image, to form a model training sample pair;
inputting the model training sample pair into the initial image encoder to obtain an initial image feature code; and
inputting the initial feature code into the image decoder to obtain an initial decoded image, and iteratively updating the initial image encoder according to a loss between the initial decoded image and the template sample image to obtain the preset image encoder.

15. The electronic device of claim 10, wherein the electronic device is caused to match the preset element removal image with the template image corresponding to the preset element displayed in the second display form based on the preset attribute parameters of the target object by:
identifying head posture data and facial key point information of the target object; and
based on the head posture data and the facial key point information, matching the template image corresponding to the preset element removed image in the multi-angle display image template set in which the preset element is displayed in the second display form.

16. The electronic device of claim 10, wherein after matching the preset element removal image with the template image corresponding to the preset element displayed in the second display form, the electronic device is caused to:
based on a facial geometry of the target object, perform image correction on a facial shape in the template image.

17. The electronic device of claim 15, wherein the electronic device is caused to establish the multi-angle display image template set in which the preset element is displayed in the second display form by:
obtaining a pre-made three-dimensional head model of the preset element displayed in the second display form; and
simulating a surround shooting process, photographing and rendering the three-dimensional head model at multiple angles, and obtaining images of the preset element displayed in the second display form at multiple angles to establish a multi-angle display image template set of the preset element displayed in the second display form.

18. The electronic device of claim 10, wherein the element removal processing model is a neural network model obtained by training based on the preset element removal image sample pair, wherein the preset element removal image sample pair includes an original sample image of an object containing the preset element, and a sample image corresponding to the original sample image that does not contain the preset element.

19. The electronic device of claim 18, wherein the electronic device is caused to obtain the sample image that does not contain the preset element by:
identifying a main outline of the preset element in the original sample image; and
processing pixel points of the preset element located in the main outline area as pixel points consistent with pixel information of the pixel points of the non-preset element in the main outline area, and processing the pixel points of the preset element located outside the main outline area as pixel points consistent with the pixel information of the pixel points of the non-preset element outside the main outline area to obtain the sample image that does not contain the preset element.

20. The medium of claim 11, wherein the preset image element migration model is caused to perform the image processing on the input image by:
performing feature fusion on the preset element removed image, the template image, and the mask image by a preset image encoder of the preset image element migration model to obtain a target feature code; and
decoding the target feature code by an image decoder of the preset image element migration model to obtain the target image, wherein the image decoder is a pre-trained image generator.

21. The medium of claim 20, wherein the processor is caused to train the preset image encoder by:
combining a sample image without the preset element of a preset object, a preset display form template sample image of the preset element matching the image without the preset element, and a mask sample image of the preset element in the template sample image, to form a model training sample pair;
inputting the model training sample pair into the initial image encoder to obtain an initial image feature code; and
inputting the initial feature code into the image decoder to obtain an initial decoded image, and iteratively updating the initial image encoder according to a loss between the initial decoded image and the template sample image to obtain the preset image encoder.

22. The medium of claim 11, wherein the processor is caused to match the preset element removal image with the template image corresponding to the preset element displayed in the second display form based on the preset attribute parameters of the target object by:
identifying head posture data and facial key point information of the target object; and
based on the head posture data and the facial key point information, matching the template image corresponding to the preset element removed image in the multi-angle display image template set in which the preset element is displayed in the second display form.
